(19) United States
(12) Patent Application Publication
(10) Pub. No.: US 2013/0106252 A1
(43) Pub. Date: May 2, 2013

(54) STATOR FIXING STRUCTURE

(71) Applicant: Eiji Yanagida, Okazaki-shi Aichi-ken (JP)

(72) Inventor: Eiji Yanagida, Okazaki-shi Aichi-ken (JP)

(21) Appl. No.: 13/660,640

(22) Filed: Oct. 25, 2012

(30) Foreign Application Priority Data
Oct. 26, 2011 (JP) 2011-234796

(51) Int. Cl. H02K 11/00; H02K 1/18

(52) U.S. Cl. 310/68 B; 310/216.113

(57) ABSTRACT

A stator fixing structure includes a case to which a detector stator having an annular outer peripheral surface is fixed; at least two knock pins protruded from seat portions of the case; and a detector stator that has an annular outer peripheral surface and that is fixed to the case while the circumferential and radial positions of the detector stator are defined as the outer peripheral surface of the detector stator contacts the knock pins at a plurality locations.

### INCORPORATION BY REFERENCE

The disclosure of Japanese Patent Application No. 2011-234796 filed on Oct. 26, 2011 including the specification, drawings and abstract is incorporated herein by reference in its entirety.

### BACKGROUND OF THE INVENTION

1. Field of the Invention

The invention relates to a stator fixing structure and, more particularly, to a stator fixing structure for fixing a stator for a resolver to a member such as an electric motor case or the like.

2. Description of Related Art

In some electric motors, a resolver for detecting the rotational position of the rotor is used. The resolver includes a resolver rotor fixed to the rotor shaft of the motor rotor and a resolver stator provided around the resolver rotor. Generally, the resolver stator is fixed to a motor case that houses the electric motor, for example, by bolt fastening or the like.

Japanese Patent Application Publication No. 2006-94582 (JP 2006-94582 A), as an example of the documents related to what is described above, discloses a fixing structure for a resolver stator which is intended to obtain excellent position detection accuracy while saving space. This fixing structure includes a resolver stator having a core that is formed in an annular shape, and a resolver case having mounting rib to which the resolver stator is fixed. The core is provided with protrusion portions that are protruded from an outer peripheral surface of the core. The mounting rib has recess cutouts that are formed in an inner peripheral surface. Therefore, the resolver stator is fixed to the mounting rib as the protrusion portions of the core of the resolver stator are pressed into the cutouts of the mounting rib. For the pressing into the cutouts, each protrusion portion has an allowance only in the direction of a tangent on an outer peripheral surface at the position where the protrusion portion is formed.

Furthermore, for example, Japanese Patent Application Publication No. 2003-244918 (JP 2003-244918 A) discloses a magnetic pole position detection apparatus for an electric motor which is intended to enable the mounting of a non-magnetic plate on the rotor body or the mounting of magnetic pieces on a non-magnetic plate with high accuracy and ease. In conjunction with this magnetic pole position detection apparatus, there is disclosed a structure in which (a) a plurality of magnetic pieces are fitted to a positioning groove formed in an end plate, and (b) knock pins made of an electrically conductive material are inserted into through-holes formed in the magnetic pieces, through-holes Banned in the end plate and guide holes formed in the rotor body which holes are aligned in position. As the knock pins are inserted into these holes, the end plate and the magnetic pieces are mounted on the rotor body.

Furthermore, for example, Japanese Patent Application Publication No. 2005-237105 (JP 2005-237105 A) discloses a rotary electric machine that is intended to facilitate the attaching of a sensor that detects the rotational position of a crankshaft in a rotary electric machine and to achieve the high-accuracy positioning of the sensor. In this rotary electric machine, commutating magnets and pulser magnets are fixed to a circular annular boss portion of an outer rotor fixed to the crankshaft, and a sensor case attached to an inner stator is provided with Hall ICs that correspond to the individual pulser magnets. The sensor case is positioned relative to the crank case by causing a protruded knock pin provided on the crank case to insert into a groove-shaped recess portion of the sensor case. Since the detection element is directly positioned relative to the crankshaft, the sites of occurrence of the attachment tolerance that affects the accuracy of the detection of the rotational position of the crankshaft can be minimized in number and the sites of possible occurrence of error at the time of attachment can be minimized in number. Therefore, the accuracy of the positioning of the Hall ICs relative to the crankshaft can be increased.

In the fixing structure for a resolver stator described in JP 2006-94582 A, since the protrusion portions protruded radially outward from the outer periphery of the resolver stator are formed, the protrusion portions function as antennas that pick up magnetic fluxes produced by the electric motor. Therefore, there is a concern that there may occur noise to a rotor position detection signal generated by the resolver and the detection accuracy of the resolver may degrade. Still further, a radially inner portion of the mounting rib for fixing the resolver stator needs to be recessed in order to avoid interference with the resolver stator, and this gives rise to a problem of the configuration of the mounting rib becoming correspondingly complicated.

Yet further, in the magnetic pole position detection apparatus for an electric motor described in JP 2003-244918 A, the end plate and the generally circular arc-shaped magnetic pieces fitted to the positioning groove of the end plate are fixed to the rotor body by inserting one knock pin into each one of the through-holes formed in the magnetic pieces. In this technology, the groove for positioning the magnetic pieces needs to be formed in the end plate beforehand, and therefore the structure cannot necessarily be said to be a simple structure. Furthermore, before a knock pin is inserted, the through hole of one of the magnetic piece and one of the through holes of the end plate and one of the guide holes of the rotor body need to be aligned. This operation needs to be performed for each one of the magnetic pieces, and thus the attaching operation is not easy.

Further, in the rotary electric machine described in JP 2005-237105 A, the protruded knock pin provided on the crank case is inserted into the recess portion of the sensor case to position the sensor case relative to the crank case. Besides, the sensor case is fixed to the inner stator by an attaching screw, and the attaching operation cannot be said to be easy.

### SUMMARY OF THE INVENTION

The invention provides a stator fixing structure that allows a stator to be fixed to a member with high accuracy and ease while being a simple structure.

A first aspect of the invention relates to a stator fixing structure that includes: a member; at least two pins protruded from the member; and a stator that is fixed to the member in a state in which circumferential position and radial position of the stator are defined as an annular outer peripheral surface of the stator contacts the pins at a plurality of locations.

The outer peripheral surface of the stator may be provided with radially recessed cutout portions at locations of contact with the pins.

Furthermore, at least one of the cutout portions and the pins may have allowances in a radial direction and a circumferential direction relative to the cutout portions.

Still further, the stator may be provided with stress-reducing holes that are formed radially inwardly of the cutout portions.

Further, the cutout portions may be formed in an outer peripheral portion of a yoke portion of the stator.

Further, the number of the pins may be three or more.

Further, the stator may be a stator for a resolver that detects rotor rotational position of an electric motor.

The stator fixing structure of the invention allows a stator to be fixed to a member with high accuracy and ease while being a simple structure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a resolver that includes a stator fixing structure in accordance with an embodiment of the invention;

FIG. 2 is a view taken as indicated by arrows II-II in FIG. 1;

FIG. 3 is an enlarged sectional view taken on line III-III of FIG. 2 and shows an example in which solid knock pins are used;

FIG. 4 is a diagram similar to FIG. 3, which shows an example in which hollow knock pins are used;

FIG. 5 is a diagram similar to FIG. 3, which shows another example that employs knock pins each of which has a stopper step portion its outer periphery;

FIG. 6 is a diagram similar to FIG. 3, which shows still another example that employs solid knock pins each of which does not have a stopper step portion on its outer periphery;

FIGS. 7A and 7B are enlarged views of a portion B shown in FIG. 2, and FIG. 7A shows an example of a generally semicircular cutout portion, and FIG. 7B shows an example of a generally trapezoidal cutout portion;

FIG. 8 is a diagram showing an example in which a stator is provided with stress-reducing holes that are formed radially inwardly of the cutout portions; and

FIG. 9 is a diagram similar to FIGS. 7A and 713 which shows an example in which the outer peripheral surface of the stator does not have a cutout portion.

### DETAILED DESCRIPTION OF EMBODIMENTS

Embodiments of the invention will be described in detail hereinafter with reference to the accompanying drawings. In the following description, the concrete shapes, materials, numerical values, directions, etc., are illustrations for facilitating the understanding of the invention, and can be appropriately changed according to uses, purposes, specifications, etc. Furthermore, if the following description includes a plurality of embodiments or modifications or the like, use of an appropriate combination of features of the embodiments and the like is assumed from the beginning.

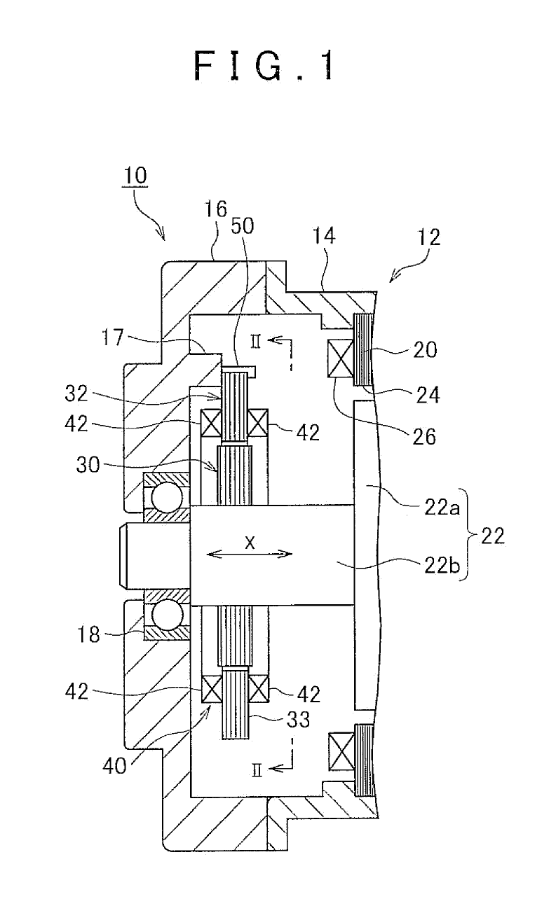

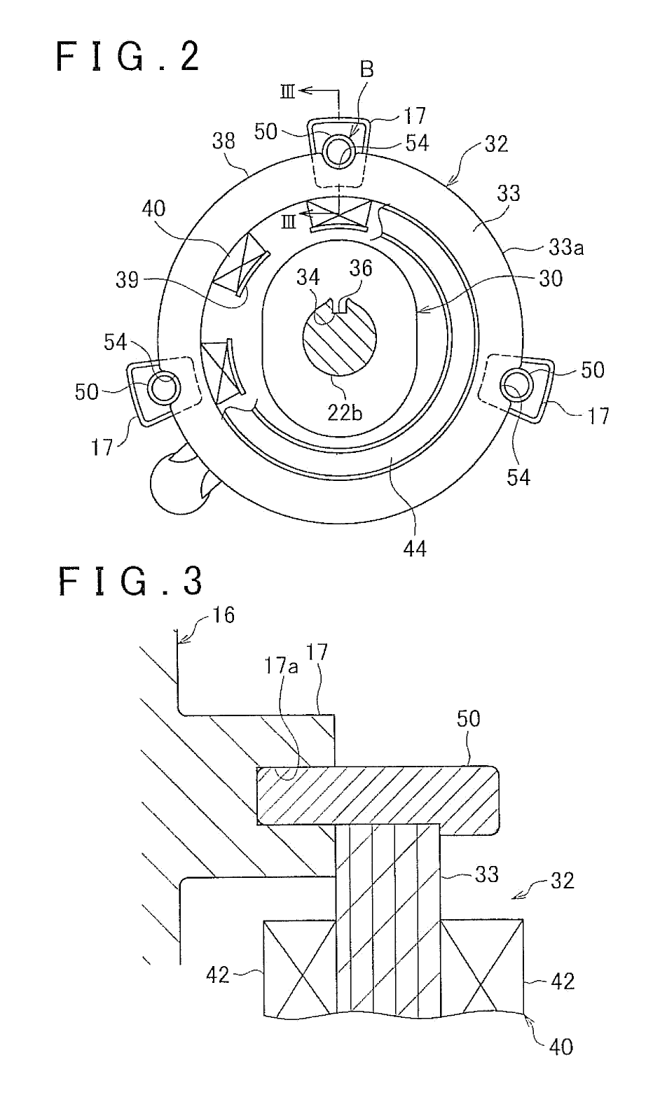

FIG. 1 is a sectional view of a resolver 10 in the axis direction to which a stator fixing structure in accordance with an embodiment of the invention is applied. FIG. 2 is a view of the resolver 10 taken as indicated by arrows in FIG. 1. Although the embodiment will be described in conjunction with examples in which the stator fixing structure is applied to the resolver 10, the stator fixing structure may also be used as a fixing structure for a stator that constitutes a rotary electric machine such as an electric motor, an electricity generator, etc.

As shown in FIG. 1, the resolver 10 is provided adjacent to an electric motor 12. The electric motor 12 is housed in a generally bottomed cylinder-shaped housing 14. An open end portion of the housing 14 is closed by a case 16 that houses the resolver 10. The housing 14 and the case 16 that are preferably used are, for example, ones that are made by aluminum die-casting.

The electric motor 12 includes a motor stator 20 and a motor rotor 22. The motor stator 20 has a cylindrical shape formed by stacking magnetic steel sheets in the axis direction, and an inner peripheral portion of the motor stator 20 is provided with a plurality of radially inwardly protruded teeth 24 that are disposed equidistantly in the circumferential direction. Stator coils 26 are wound around the teeth 24.

The motor rotor 22 includes a generally cylindrical rotor core 22a, and a rotor shaft 22b that penetrates a center hole portion of the rotor core 22a and is fixed thereto. The rotor core 22a is disposed at an inner side of the motor stator 20 with a predetermined gap therebetween. The rotor shaft 22b of the electric motor 12 is rotatably supported by a bearing 18 disposed in a central portion of the case 16 and a bearing (not shown) disposed in a central portion of a bottom portion (not shown) of the housing 14.

The resolver 10 includes a detector rotor 30 and a detector stator 32. The detector rotor 30 is constructed, for example, by stacking a plurality of generally elliptical punched-out magnetic steel sheets in the axis direction and firmly connecting them together by swaging, welding, etc.

The rotor shaft 22b extending from the electric motor 12 is inserted in a center hole of the detector rotor 30. An edge of the center hole of the detector rotor 30 is provided with a protruded key 34 (see FIG. 2). The key 34 is fitted into a key groove 36 that is formed in the rotor shaft 22b, so that the circumferential position (the position in the circumferential direction) of the detector rotor 30 relative to the rotor shaft 22b is defined. When the detector rotor 30 is attached to an end portion of the rotor shaft 22b (a left side end thereof in FIG. 1) with the end portion inserted in the center hole of the detector rotor 30, an end surface of the detector rotor 30 in the axis direction contacts a protruded abutment portion (not shown) provided on the rotor shaft 22b, so that the axial position (the position in the axis direction) of the detector rotor 30 relative to the rotor shaft 22b is defined.

Although in the foregoing description, the circumferential position of the detector rotor 30 is defined by the fitting of the key 34 and the key groove 36, this is not restrictive. For example, the circumferential position and/or the axial position of the detector rotor relative to the rotor shaft may also be fixed by the pressing of the detector rotor onto the rotor shaft, the close fitting of the detector rotor to the rotor shaft, etc.

The detector stator 32 of the resolver 10 is provided around the detector rotor 30 with a gap therebetween. The detector stator 32 includes a stator core 33 that is constructed, for example, by staking a plurality of generally circular annular punched-out magnetic steel sheets in the axis direction and firmly connecting them together by swaging, welding, etc.

The stator core 33 includes a yoke portion 38 continuously extending in a circular annular shape, and a plurality of radially inwardly protruded tooth portions 39 provided on an inner peripheral portion of the yoke portion 38. The tooth portions 39 are provided equidistantly in the circumferential direction. A detector coil 40 is wound around each of the tooth portions 39. The detector coils 40 include coil end portions 42 that are axially protruded from two axially opposite end surfaces of the stator core 33.

It is preferable that the detector coils 40 be covered with a circular annular resin cover member 44 as shown in FIG. 2. This cover member 44 is provided so as to cover the detector coils 40 over an entire circumference, with an end surface of each tooth portion 39 exposed to the inner peripheral surface of the detector stator 32. In FIG. 2, the illustration of the cover member 44 is partially broken and removed in order to facilitate the visual recognition of the tooth portions 39 and the detector coils 40. Furthermore, in FIG. 1, illustration of the cover member is omitted.

The cover member 44 can be formed, for example, by performing insert molding in molding dies in which the stator core 33 with the detector coils 40 wound thereon is placed. Furthermore, it is preferable that the cover member 44 cover the coil end portions 42 of the detector coils 40 at the two opposite sides of the detector stator 32 in the axis direction. Thus, by covering the detector coils 40 with the cover member 44, cooling oil used to cool the motor rotor 22 and the stator coils 26 of the electric motor 12 is prevented from reaching the detector coils 40 of the resolver 10. This structure prevents deterioration of the electrical insulation performance of the detector coils 40 resulting from deposition of electrically conductive substances such as metal dust or the like contained in the cooling oil, so that high detection accuracy of the resolver 10 can be maintained.

In the resolver 10 constructed as described above, as the electric motor 12 is driven rotating the motor rotor 22, the detector rotor 30 rotates together with the rotor shaft 22b. At this time, the length of the gap (interval) between the outer peripheral surface of the generally elliptical detector rotor 30 and the inner peripheral surface of the detector stator 32 (i.e., the radially inward end surfaces of the tooth portions 39) changes. Therefore, if alternating electric current is caused to flow through the detector coils 40, the alternating current is superposed with output that is commensurate with changes in the gap length. The rotational position of the motor rotor 22 can be detected on the basis of the alternating current superposed with the output.

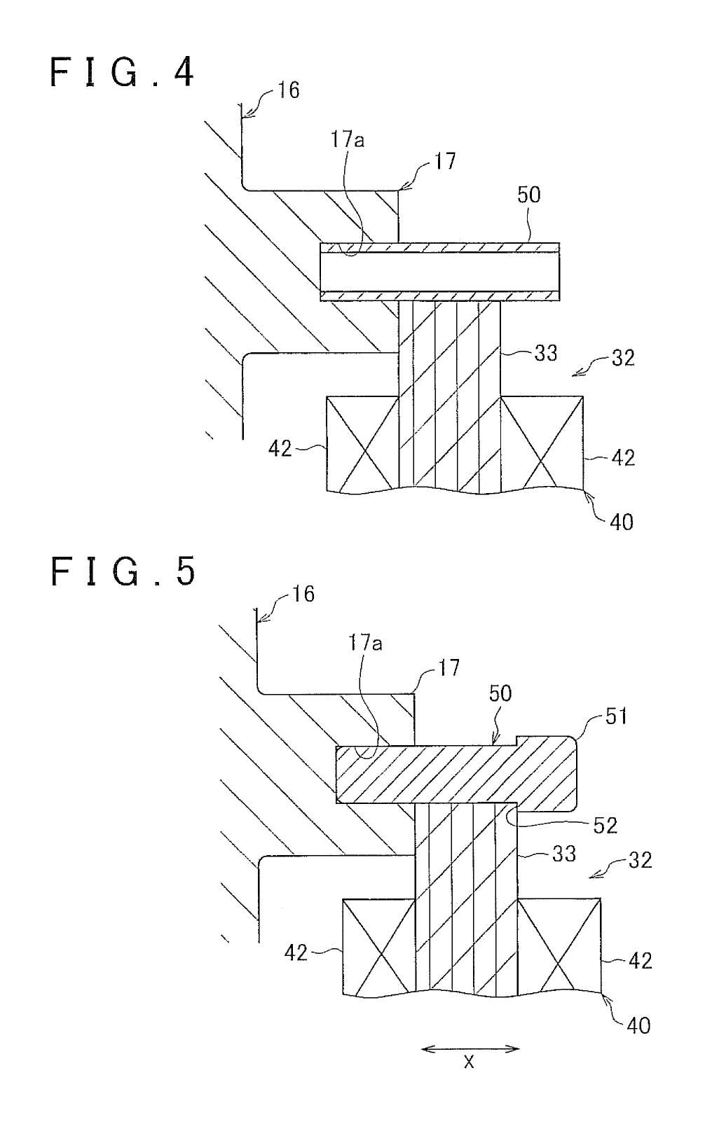

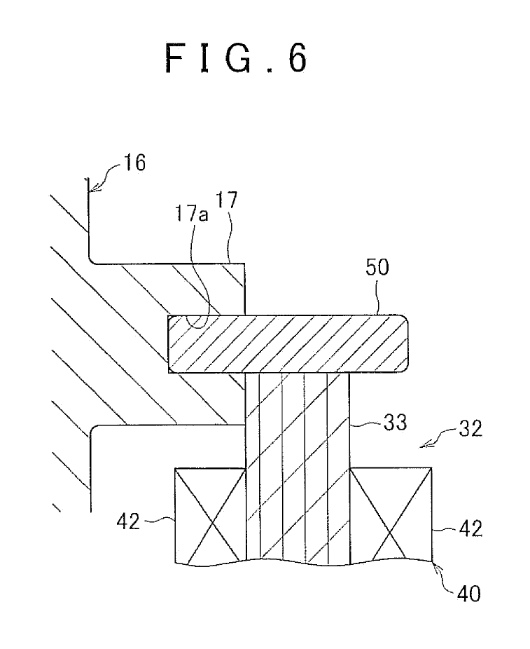

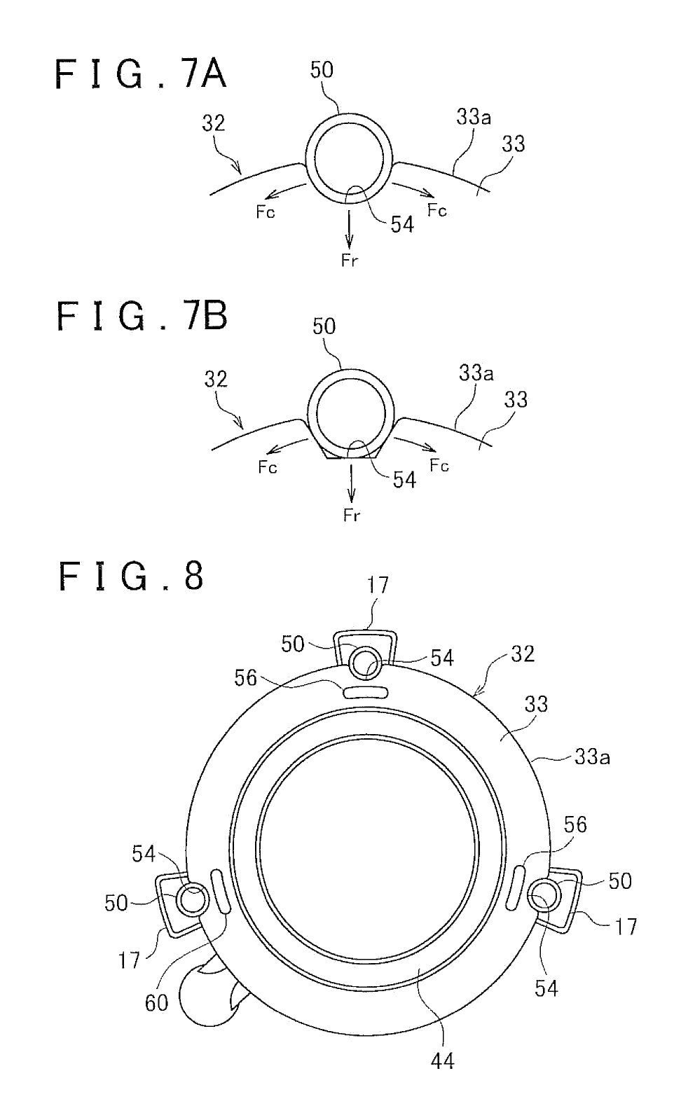

Next, the stator fixing structure in accordance with the embodiment will be described in detail with reference to FIGS. 3 to 6 in addition to FIGS. 1 to 2. FIG. 3 is an enlarged sectional view taken on line of FIG. 2 and shows an example in which solid knock pins are used. FIG. 4 is a diagram similar to FIG. 3, which shows an example in which hollow knock pins are used. FIG. 5 is a diagram similar to FIG. 3, which shows another example that employs knock pins each of which has a stopper step portion its outer periphery. FIG. 6 is a diagram similar to FIG. 3, which shows still another example that employs solid knock pins each of which does not have a stopper step portion on its outer periphery. FIGS. 7A and 7B are enlarged views of a portion B shown in FIG. 2. FIG. 7A shows an example of a generally semicircular cutout portion, and FIG. 7B shows an example of a generally trapezoidal cutout portion.

Referring to FIGS. 1 and 2, protruded seat portions 17 are provided on an inner surface of the case 16 that houses the resolver 10. Each seat portion 17 has a shape of, for example, a column having a generally trapezoidal cross-section and a generally trapezoidal end surface that is formed to be a flat surface. The seat portions 17 extend in the axis direction shown by a double arrow X, and the protrusion length of the seat portions 17 is set to such a size that the cover member 44 (or the coil end portions 42) does not contact the inner surface of the case 16 when the detector stator 32 is mounted on the seat portions 17.

Furthermore, the number of the seat portions 17 is two or more, and the seat portions 17 are provided at intervals in the circumferential direction along the outer periphery of the detector stator 32 as shown in FIG. 2. In conjunction with this embodiment, example constructions in which three seat portions 17 are provided are shown. The circumferential intervals between the seat portions 17 may be equal intervals or unequal intervals. In the case where the circumferential intervals between the seat portions 17 is set to be unequal, the mounting orientation of the detector stator 32 is uniquely determined on the basis of the relation between the seat portions 17 and cutout portions formed in the outer peripheral surface of the stator (described later), and therefore this setting has an advantage of being able to certainly prevent the mounting orientations of the detector stators 32 from varying among the final assemblies.

Although in the embodiment, the seat portions 17 are provided discretely or at intervals in the circumferential direction, this arrangement is not restrictive. For example, a seat portion that continuously extends in a circular annular shape may be adopted. This construction increases the contact area between the axial end surface of the seat portion and an outer edge portion (radially outer portion) of an axial end surface of the stator core of the detector stator, and therefore has an advantage of making the fixed state of the detector stator 32 more stable.

On the end surface of each seat portion 17 there is provided a knock pin 50 that is protruded in the axis direction. The knock pins 50 are fixture members for contacting the outer peripheral surface of the detector stator 32 so as to fix the detector stator 32 while the circumferential and axial positions of the detector stator 32 are determined relative to the case 16. Each knock pin 50 is fixed by pressing it into a bottomed pin hole 17a that is formed in an end surface portion of the seat portion 17 so as to extend in the axis direction, as shown in FIG. 3. The knock pins 50 can be preferably constructed by, for example, round metal rod members. The knock pins 50 may be solid pins as shown in FIG. 3, or may also be hollow pins as shown in FIG. 4.

Furthermore, each knock pin 50 may be provided with a stopper step portion 52 as shown in FIG. 5. The stopper step portion 52 may be formed, for example, by an increased-diameter end portion 51 of the knock pin 50. The use of the knock pins 50 each provided with the stopper step portion 52 has an advantage of achieving a further secured fixture of the detector stator 32 in the axis direction by the stopper step portion 52 latching onto an outer peripheral edge portion of the stator core 33 of the detector stator 32. The stopper step portion may also be provided only on a portion of the circumferential direction as shown in FIG. 3. Such a stopper step portion of each knock pin 50 can also fix the detector stator 32 and prevent the detector stator 32 from shifting in the axis direction.

The foregoing construction in which the knock pins 50 for fixing the detector stator 32 to the case 16 are provided as separate members from the detector stator 32 and the case 16 achieves an advantage of making the stator fixing structure simple in construction. Concretely, it suffices that the end surface of each protruded seat portion 17 of the case 16 is formed as a flat surface, and therefore the fabrication of casting dies, molding dies, etc. for producing the case 16 becomes easy. Furthermore, there is no need to pre-fix the knock pins 50 to the stator core 33, so that the production of the detector stator 32 becomes easy. Still further, if the knock pins 50 are obtained as inexpensive commercial products, a considerable cost reducing effect can be attained.

In the stator fixing structure of the embodiment, the three knock pins 50 corresponding to the number of the seat portions 17 are used. The construction in which the detector stator 32 is fixed by using the three knock pins 50 in this manner makes it possible to certainly define the radial and circumferential positions of the detector stator 32 while reducing the number of component parts and facilitating the assembling operation. However, it is a matter of course that the number of the knock pins 50 (and the number of the seat portions 17) may be four or more. Furthermore, the number of the knock pins 50 may also be two; however, in that construction, it is appropriate to provide the knock pins 50 so that the knock pins 50 contact the outer peripheral surface of the stator core 33 at positions that are substantially opposite to each other in the direction of the diameter of the detector stator 32.

Referring back to FIG. 2, the stator core 33 that constitutes the detector stator 32 has an annular shape, and the outer peripheral surface of the stator core 33 is provided with the radially inwardly recessed cutout portions 54. The cutout portions 54 are portions at which the generally cylindrical outer peripheral surface of the stator core 33 contacts the knock pins 50. In this embodiment, three cutout portions 54 are provided corresponding to the number of the knock pins 50.

The cutout portions 54 are formed in the outer peripheral surface of the stator core 33 that constitutes the detector stator 32, that is, the outer peripheral surface of the yoke portion 38 of the stator core 33. Forming the cutout portions 54 in the yoke portion 38 as described above will restrain the influence that the cutout portions 54 have on the magnetic circuit in the stator core 33, and will maintain high detection accuracy of the resolver.

Furthermore, as shown in FIG. 7A, the cutout portions 54 are each formed, for example, as a cutout that has such a generally semicircular edge portion as to substantially conform with an external shape of the knock pin 50 and have a surface contact with the knock pin 50. Then, when the detector stator 32 is fixed by the knock pins 50 contacting or pressingly contacting the three cutout portions 54 disposed discretely in the circumferential direction, there occurs a friction (an interference) by which the knock pins 50 press the cutout portions 54 in the radial and circumferential directions. As a result, the edge portion of each cutout portion 54 receives a radial-direction pressing force Fr and a circumferential-direction pressing force Fc. Due to these pressing forces Fr and Fc, the detector stator 32 is fixed to the case 16 provided with the protruded knock pins 50 while the detector stator 32 is fixed in position in the radial direction and the circumferential direction.

Incidentally, in the case where hollow knock pins 50 as shown in FIG. 4 are used, by adopting a construction in which the knock pins 50 easily deform due to the pressing contact with the cutout portions 54, it is permissible that the knock pins 50 and the cutout portions 54 may take their shares of the fitting allowance therebetween or that only the knock pins 50 may be provided with the fitting allowance.

It is preferable that the radially inward cut-in depth of the cutout portions 54 be set so that the radial-direction pressing force Fr that the knock pins 50 exert on the stator core 33 will not cause in the detector stator 32 radial stress strain that affects the detection accuracy.

The shape of the cutout portions 54 is not limited to the generally semicircular shape, but may be other shapes, for example, a trapezoidal shape as shown in FIG. 7B. In the case where the cutout portions 54 have such a trapezoidal shape, both the circumferential position and the radial position of the detector stator 32 can be defined as two circumferentially opposite side edge portions (side surfaces) of each cutout portion 54 contact the outer peripheral surface of a corresponding one of the knock pins 50. Therefore, a radially inner side edge portion (bottom portion) of each cutout portion 54 may contact a corresponding one of the knock pins 50 substantially without any allowance, or may have a clearance from the corresponding knock pin 50 and be free of contact therewith. Then, the radial-direction pressing force that the knock pins 50 exert on the stator core 33 can be made small or zero, and therefore high detection accuracy of the resolver 10 can be achieved.

Next, assembly of the stator fixing structure of the embodiment will be described. The assembly of the stator fixing structure can be considered to be carried out in the following three patterns. Of course, the stator fixing structure may also be assembled in an assembling procedure other than the three patters.

In the first pattern, firstly, the three knock pins 50 are struck into the seat portions 17 of the case 16. After that, the cutout portions 54 of the detector stator 32 are aligned in position with the knock pins 50, and while this aligned state is maintained, the detector stator 32 is pressed into a region that is substantially defined by the three knock pins 50. At this time, the detector stator 32 is pushed in until an outer edge portion of the axial end surface of the stator core 33 facing the seat portions 17 contacts the flat end surfaces of the seat portions 17. As a result, the detector stator 32 is fixed by the case 16 with the circumferential and radial positions of the detector stator 32 defined to the three knock pins 50. Furthermore, the fastening force and the friction force caused by the pressing contact between the knock pins 50 and the cutout portions 54 fix the detector stator 32 in position in the axis direction (the position in the direction of the double arrow X).

In the second pattern, firstly, two of the three knock pins 50 are struck into two of the seat portions 17 of the case 16. After that, the detector stator 32 is placed on the seat portions 17 with two of the cutout portions 54 of the detector stator 32 aligned in position with the two knock pins 50. Then, the third knock pin 50 is struck into the third seat portion 17. By this procedure, the detector stator 32 is fixed to the case 16 with the circumferential and radial positions of the detector stator 32 defined by the three knock pins 50.

In the third pattern, firstly, the detector stator 32 is placed on the three seat portions 17 with the three cutout portions 54 of the detector stator 32 aligned in position with the pin holes 17a of the seat portions 17. Then, the three knock pins 50 are simultaneously struck into the pin holes 17a of the seat portions 17 so as to be protruded from the seat portions 17. By this procedure, the detector stator 32 is fixed to the case 16 with the circumferential and radial positions of the detector stator 32 defined by the three knock pins 50.

As described above, according to the stator fixing structure of the embodiment, the detector stator 32 can be fixed to the case 16 in a state in which the circumferential and radial positions of the detector stator 32 are defined as the outer peripheral surface of the stator core 33 contacts the three protruded knock pins 50 provided on the case 16. Therefore, it is possible to fix the detector stator 32 to the case 16 with high accuracy and ease while using a simple structure for the fixation.

Furthermore, since the circumferential position of the detector stator 32 is defined when attached to the case 16, it is no longer necessary to adjust the circumferential position of the detector stator 32 after the detector stator 32 is attached, and therefore the assembling process can be shortened and simplified.

Furthermore, since the detector stator 32 is fixed to the case 16 without employing a bolt fastening process, there is no need to form bolt-insertion through-holes in the stator core 33 of the detector stator 32. Therefore, by omitting correspondingly unnecessary portions or masses, the stator 33 can be made smaller in diameter and therefore the resolver can be reduced in size, and the material cost can be cut down.

Furthermore, by adopting a construction in which the regions where the knock pins 50 exert pressing forces on the cutout portions 54 in radial directions are made small relative to the entire circumferential region and the cut-in depth of the cutout portions 54 are appropriately set, it is possible to restrain occurrence of the radial stress strain in the stator core 33 that affects the detection accuracy of the resolver.

Incidentally, the stator fixing structure of the invention is not limited to the constructions of the foregoing embodiments or their modifications, various changes and improvements thereof can be made.

For example, as shown in FIG. 8, in a stator core 33 that constitutes a detector stator 32, holes 56 for reducing stress may be formed radially inwardly of the cutout portions 54. The stress-reducing holes 56 are preferably formed, for example, as elongated holes that each extend over at least the length of the diameter of the knock pins 50. The provision of the stress-reducing holes 56 more certainly restrains the deformation and the stress strain of portions of the stator core 33 that serve as magnetic circuits.

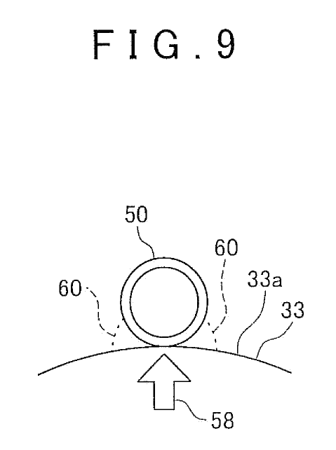

Furthermore, as shown in FIG. 9, the stator core 33 of the detector stator 32 may also be provided without a cutout portion in the outer peripheral surface of the stator core 33. In this case, a marking 58 that indicates the position of contact with a knock pin 50 may be provided on an axial end surface of the stator core 33 beforehand, and when the detector stator 32 is attached, the marking 58 is aligned with the knock pin 50 to define the circumferential position of the detector stator 32. Alternatively, at least one knock pin 50 may be fixed on an outer peripheral surface 33a of the stator core 33 by a weld portion 60 beforehand, and the circumferential position of the detector stator 32 may be defined by striking the knock pin 50 fixed to the stator core 33 into a predetermined seat portion 17.

Furthermore, the foregoing embodiments have been described in conjunction with a construction in which the protruded pins on the seat portions 17 of the case 16 are knock pins separate from the case 16 and the detector stator 32. However, pins integrated with the case or the detector stator beforehand may be protruded from the seat portions.

What is claimed is:

1. A stator fixing structure comprising:
a member;
at least two pins protruded from the member; and
a stator that is fixed to the member in a state in which circumferential position and radial position of the stator are defined as an annular outer peripheral surface of the stator contacts the pins at a plurality of locations.

2. The stator fixing structure according to claim 1, wherein
the outer peripheral surface of the stator is provided with radially recessed cutout portions at locations of contact with the pins.

3. The stator fixing structure according to claim 2, wherein
at least one of the cutout portions and the pins have allowances in a radial direction and a circumferential direction relative to the cutout portions.

4. The stator fixing structure according to claim 2, wherein
the stator is provided with stress-reducing holes that are formed radially inwardly of the cutout portions.

5. The stator fixing structure according to claim 2, wherein
the cutout portions are formed in an outer peripheral portion of a yoke portion of the stator.

6. The stator fixing structure according to claim 1, wherein
the number of the pins provided is three or more.

7. The stator fixing structure according to claim 1, wherein
the stator is a stator for a resolver that detects rotor rotational position of an electric motor.

8. A resolver comprising:
a stator fixing structure according to claim 1; and
a detector rotor configured so that an interval between an outer peripheral surface of the detector rotor and an inner peripheral surface of the stator varies in a circumferential direction.
